(19) United States
(12) Patent Application Publication
(10) Pub. No.: US 2005/0208979 A1
(43) Pub. Date: Sep. 22, 2005

(54) System and method for verifying delay time using mobile image terminal

(75) Inventor: Joo Min Kim, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/086,197

(22) Filed: Mar. 21, 2005

(30) Foreign Application Priority Data
Mar. 22, 2004 (KR) 10-2004-0019385

(51) Int. Cl. H04M 1/00

(52) U.S. Cl. 455/566; 455/418

(57) ABSTRACT

The present invention relates to a mobile terminal, to a system and a method capable of monitoring in real-time a delay time of data transmitted/received between terminals in mobile terminals. According to the method, a terminal at a transmission side encodes data for an image call, transmits the encoded data to a terminal at a reception side, and receives the transmitted data as a loop-back to decode the same. An external monitoring device measures delay time information of the data using encoding and decoding time information and displays the information on a screen.

### BACKGROUND OF THE INVENTION

1. Field of the Invention

The present invention relates to a mobile terminal, and more particularly, to a system and a method capable of monitoring in real-time a delay time of data transmitted/received between terminals in mobile terminals.

2. Description of the Related Art

A recent mobile telephone terminal has a camera for its indispensable element to provide a user with image communication service that uses voice and an image as well as communication service that uses voice.

For transmission of moving image information containing multimedia data on a mobile communication channel, image data, audio data, and control data are multiplexed and transmitted. International Telecommunications Union—Telecommunication Standardization Sector (ITU-T) H.324 multimedia terminal standard generally prescribes mobile image telecommunication under a circuit-switched environment.

H.324 is a protocol of an image telephone and a terminal system for a conference that use public switched telephone network (PSTN). H.245 is a protocol for processing a control message exchanged for initiation or termination of communication between H.324-based two terminals and acts as a control protocol of an H.324-based system. H.245 acts as the control protocol for H.323 as well as H.324. These protocols as indispensable modules for multimedia communication is under development.

FIG. 1 is a schematic, block diagram illustrating a construction of a general H.324 multimedia telecommunication system.

As illustrated in FIG. 1, the H.324 multimedia telecommunication system includes a terminal equipment 100, a general switched telephone network (GSTN) 110, and an multipoint control unit (MCU) 120.

The terminal equipment 100 includes a video codec 102, an audio codec 104, a multiplexer/demultiplexer 106, and a modulator 108.

The multiplexer/demultiplexer 106 multiplexes video data, audio data, and control data using a single stream when transmitting data and divides a received bit stream into a variety of multimedia streams such as video data, audio data, and control data when receiving the stream.

The modulator 108 modulates a bit stream multiplexed at the multiplexer/demultiplexer 106 into an analog signal to transmit the modulated analog signal to the GSTN 110 when transmitting data and delivers received analog data by a multiplex unit appropriate for the multiplexer/demultiplexer 106 when receiving the analog data.

The terminal equipment 100 transmits signals compressed at the video codec 102 and the audio codec 104 to the multiplexer/demultiplexer 106. The multiplexer/demultiplexer 106 multiplexes the compressed signals to transmit the multiplexed signals to the GSTN 110 through the modulator 108.

Further, the terminal equipment 100 exchanges messages between two terminals for appropriate operation control using a control protocol with respect to a channel such as a mobile communication channel where probability of error generation is high. The GSTN interface provides an appropriate signaling, bell function depending on a standard.

In case the image telecommunication is realized on the basis of H.324 which is a mobile telecommunication multimedia protocol as described above, a delay time between the two terminals is very important. However, it is impossible to quantitatively measure an image delay time between two terminals in a real-time image telecommunication system. Also, there is no tool capable of monitoring in real-time a measured delay time.

### SUMMARY OF THE INVENTION

Accordingly, the present invention is directed to a system and a method for verifying a delay time using a mobile image terminal that substantially obviate one or more problems due to limitations and disadvantages of the related art.

An object of the present invention is to provide a system and a method for verifying a delay time between mobile image terminals capable of quantitatively measuring a data delay time generated during an image call between image telephone terminals.

Another object of the present invention is to provide a system and a method for verifying a delay time between mobile image terminals capable of comparing/analyzing use environments of terminals and video data change amounts of the terminals as well as measuring in real-time a delay time during a mobile image call.

A further another object of the present invention is to provide a system and a method for verifying a delay time between mobile image terminals capable of improving image call quality even more on the basis of data delay information between mobile image terminals using a monitoring device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a system for verifying a delay time using mobile image terminals includes: a terminal at a reception side for looping back received data; a terminal at a transmission side for transmitting data to the terminal at the reception side, and receiving the same data as the transmitted data through a loop-back from the terminal at the reception side to measure a delay time of the data; and a monitoring device for monitoring delay time information of the data measured by the terminal at the transmission side to output the delay time information of the data.

In another aspect of the present invention, there is provided a method for verifying a delay time using mobile image terminals, which includes: transmitting, at a terminal at a transmission side, data for an image communication; receiving again the same data as the transmitted data through a loop-back of a terminal at a reception side; and monitoring in real-time, at a monitoring device, time information generated by the transmitted data and the loop-back data to output a delay time information of the data.

According to the present invention, time information generated at data transmission point and time information generated when the same data is received again are monitored in real-time using two terminals and one monitoring device, whereby the data delay time information can be measured and better image telecommunication service can be provided on the basis of such information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic, block diagram illustrating a construction of a general H.324 multimedia telecommunication system;

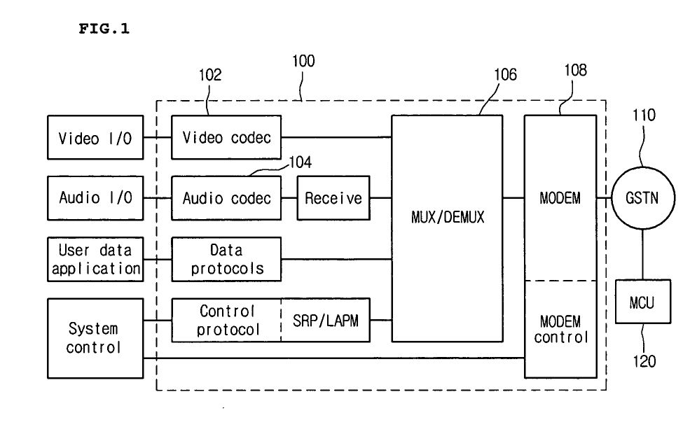

FIG. 2 is a block diagram of a system for verifying a delay time between mobile image terminals according to a preferred embodiment of the present invention;

FIG. 3 is a view illustrating a detailed construction of a first terminal shown in FIG. 2;

FIG. 4 is a view illustrating a detailed construction of a second terminal shown in FIG. 2;

FIG. 5 is a flowchart of a method for verifying a delay time between mobile image terminals according to a preferred embodiment of the present invention; and

FIG. 6 is a flowchart of a method for verifying a delay time between mobile image terminals according to another embodiment of the present invention.

### DETAILED DESCRIPTION OF THE INVENTION

Reference will now be made in detail to the preferred embodiments of the present invention, examples of which are illustrated in the accompanying drawings.

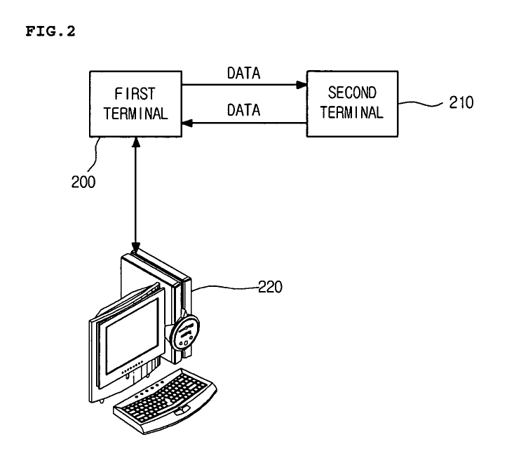

FIG. 2 is a block diagram of a system for verifying a delay time between mobile image terminals according to a preferred embodiment of the present invention.

Referring to FIG. 2, the system includes: a first terminal 200 for transmitting/receiving data for an image call and measuring a delay time of data being looped back; a second terminal 210 for re-transmitting the data received from the first terminal 200 to the first terminal 200; and a monitoring device 220 for outputting delay time information measured by the first terminal 200.

The data transmitted by the first terminal 200 includes audio data, video data, and control data. The data is multiplexed by a multiplexer and transmitted.

The first terminal 200 is connected with the second terminal 210 for an image call through a wireless network. At this point, the data that has been transmitted by the first terminal 200 to the second terminal 210 is looped back to the first terminal 200, so that the first terminal 200 can receive the same data.

In other words, if the first terminal 200 selects video data inputted in real-time from a camera or video data stored in a memory for an image call, the selected video data, audio data, and control data are multiplexed and transmitted to the second terminal 210. At this point, the first terminal 200 detects and records an encoding time when encoding the video data.

The second terminal 210 demultiplexes the received multiplexed data in a form appropriate for the respective media types and transmits the same to a relevant channel. Simultaneously, the received multiplexed data is transmitted to the first terminal 200 again.

Then, after demultiplexing the multiplexed data received from the second terminal 210, the first terminal 200 detects and records a decoding-start time when decoding the video data.

Accordingly, the encoding time recorded when the video data is encoded is compared with the decoding time recorded when the video data is decoded. A delay time by a difference between the encoding time and the decoding time of the video data can be computed using the comparison results. The delay time means a delay time for both directions.

The encoding time of the video data is a frame encoding-termination time when compression of the video data is completed. The decoding time of the video data is a frame decoding-termination time when the video data is recovered. That is, the frame encoding-termination time is subtracted from the frame decoding-termination time using a system time for a reference time, whereby a delay time between the two frames can be measured. For another example, the delay time can also be measured using a frame encoding start time and a frame decoding start time.

As described above, the first terminal 200 can measure whether the video data frame has been lost and lost frame information as well as the delay time by encoding and decoding the same video data. Further, whether the frame lost is generated by a network error can be checked.

Further, the first terminal 200 transmits the measured information to a monitoring device. The monitoring device can be connected with the first terminal 200 through a wired or wireless channel. In case the monitoring device is connected with the first terminal 200 through the wired channel, the first terminal 200 is connected with the monitoring device 220 using a serial port.

The monitoring device 220 receives in real-time a variety of measured information regarding the image call of the first terminal 200. That is, the first terminal 200 transmits in real-time a delay time of the frame, whether the frame has been lost by the network error, lost frame information to the monitoring device 220.

The monitoring device 220 quantitatively displays, with a real-time monitoring tool, in real-time an average delay time by a frame unit and by a minute/second unit using the delay time, whether the frame has been lost, the lost frame information which are transmitted from the first terminal.

The monitoring device 220 can compute information of the number of an entire frames, the number of falsely received frames, an average of the delay time, a maximum delay time, and a minimum delay time with respect to the measured data, and quantitatively display the computed information. The quantitative information can be used in improving image call quality.

The monitoring device 220 can store and open the data values measured by the monitoring tool and load a plurality of stored files to compare and analyze the loaded files. As descried above, the monitoring device 220 can compare/analyze the data measured at a variety of places and times and apply various changes to the video data to compare/analyze the delay time due to image data change amounts.

In the meantime, for another example, the first terminal 200 transmits in real-time a time when the data is encoded and a time when the data is decoded to the monitoring device 220. Accordingly, the monitoring device 220 can measure the delay time using the difference between the time when the data is encoded and the time when the data is decoded and display information on a screen using the measured delay time.

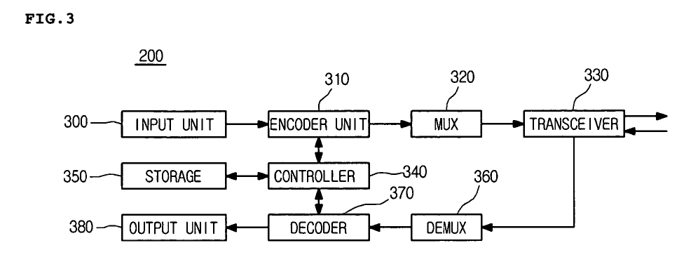

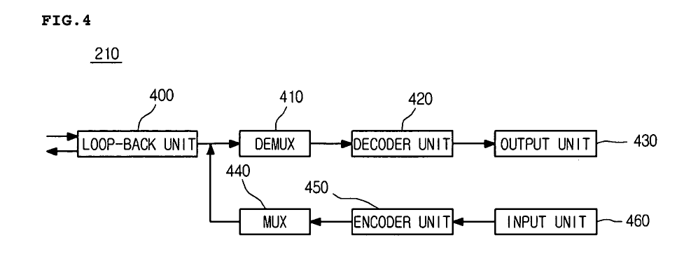

The first terminal 200 and the second terminal 210 will be described in detail with reference to FIGS. 3 and 4.

First, referring to FIG. 3, the first terminal 200 includes an input unit 300, an encoder unit 310, a multiplexer (MUX) 320, a transceiver 330, a controller 340, a storage 350, a DEMUX (demultiplexer) 360, a decoder unit 370, and an output unit 380.

The input unit 300 is a means for inputting video data and audio data such as a camera and a mike.

The encoder unit 310 is a means for encoding data inputted through the input unit 300 and includes a video encoder for encoding video data and an audio encoder for encoding audio data. At this point, the controller 340 records an encoding time of a frame in the storage 350 when the data is encoded.

The MUX 360 is a multiplexer and multiplexes video data, audio data transmitted from the encoder unit 310, and control data of the controller to transmit the multiplexed data to the transceiver 330. The transceiver 330 transmits the multiplexed data to the second terminal 210 and receives data from the second terminal 210.

The DEMUX 360 is a demultiplexer. If the multiplexed data transmitted to the second terminal 210 is received, the DEMUX 360 demultiplexes the data and transmits the demultiplexed data to the decoder unit 370. At this point, the received multiplexed data is the same data as the transmitted multiplexed data.

The decoder unit 370 decodes the demultiplexed data transmitted from the DEMUX 360 and includes a video decoder for decoding the video data and an audio decoder for decoding the audio data. At this point, the controller 340 records a decoding time of a frame in the storage 350 when the data is decoded.

Here, the video encoder and the video decoder functions as a video codec and the audio decoder and the audio decoder functions as an audio codec.

The decoded data is outputted through the output unit 380. Here, the output unit 380 includes a display and a speaker. The display displays the decoded video data and the speaker outputs the decoded audio data.

The controller 340 stores encoding time information of data encoded by the encoder unit 310 in the storage unit 350 and decoding time information of data decoded by the decoder unit 370 in the storage unit 350. The data is video data, for example.

The controller 340 measures the delay time information that includes a delay time of an image frame in both directions, whether a relevant frame has been lost by a network error, a frame lost by the network error using the encoding and the decoding time information stored in the storage 350. That is, the controller 340 can measure the delay time information and the frame information by comparing/analyzing the number of frames and the frame encoding time when the data is encoded and the number of frames and the frame decoding time when the data is decoded. The controller 340 can check whether the frame has been loss by checking whether the frame can be recovered when the frame is recovered.

The controller 340 transmits the measured information to the monitoring device through a connector not shown. Here, regarding the transmission period, the measured information can be transmitted in real-time or can be transmitted by a measurement data unit of a predetermined size.

In the meantime, the second terminal 210 will be described in detail with reference to FIG. 4.

Referring to FIG. 4, the second terminal 210 includes a loop-back unit 400, a DEMUX 410, a decoder unit 420, an output unit 430, a MUX 440, an encoder unit 450, and an input unit 460.

The loop-back unit 400 transmits data received from the first terminal 200 to the DEMUX 410 and transmits the received data back to the first terminal 200. The second terminal 200 loops back the multiplexed data received from the first terminal 200 using the loop-back unit 400 to transmit the received data back to the first terminal 200.

Since the DEMUX 410, the decoder unit 420, the output unit 420, the MUX 440, and the encoder unit 450, and the input unit 460 are the same as those of FIG. 3, detailed description thereof will be omitted.

The two terminals 200 and 210 shown in FIGS. 3 and 4 are arbitrary phones and operate on the basis of a predetermined application (image telecommunication—H.324) in a wireless network. If one terminal transmits encoded data to verify the delay time, the other terminal transmits the data received from the one terminal, as it is, back to the one terminal in stead of transmitting data that has came through a camera. Through such process, to what extent the delay time is generated during an image call can be checked.

Accordingly, the monitoring device outputs in real-time an average delay time of a frame unit and a minute/second unit and an average of the delay time, and numerically outputs an average of the delay time, a maximum delay time, and a minimum delay time using the delay time, whether the frame has been lost, and lost frame information that have been transmitted from the first terminal. A user or a developer can know the frame data lost and the delay time using analysis results outputted by the monitoring device.

That is, the monitoring device 220 stores the delay time information transmitted from the first terminal 200 and loads a plurality of stored files to compare/analyze the loaded files. Through such process, a user can compare/analyze data measured at variety of places and times and apply various changes to the image data to compare/analyze the delay time due to image data change amounts.

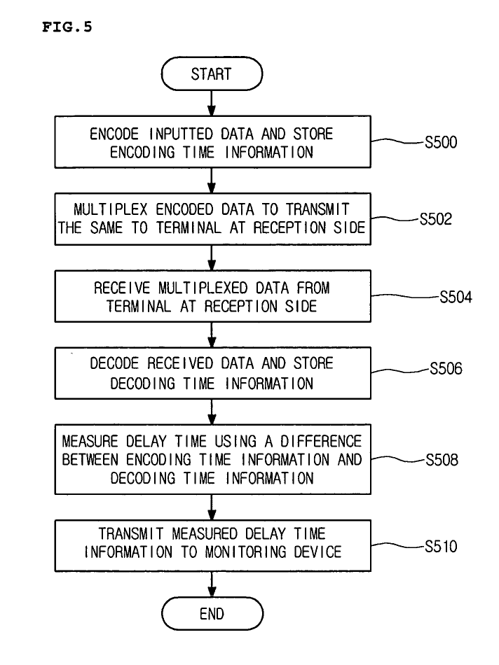

FIG. 5 is a flowchart of a method for verifying a delay time between mobile image terminals according to a preferred embodiment of the present invention.

Referring to FIG. 5, the terminal at the transmission side encodes inputted data and simultaneously stores the encoding time information in the storage (S500), and multiplexes the encoded data to transmit the multiplexed data to the terminal at the reception side (S502).

The terminal at the reception side transmits the multiplexed data back to the terminal at the transmission side and simultaneously decodes the multiplexed data to output the decoded multiplexed data.

If the same multiplexed data as the data transmitted by the terminal at the transmission side is received from the terminal at the reception side after S502 is performed (S504), the terminal at the reception side decodes the received multiplexed data and simultaneously stores the decoding time information (S506).

After that, the terminal at the transmission side measures the delay time using the stored encoding/decoding time information (S508) and transmits the measured delay time information to the monitoring device (S510).

Here, for the data for use in measuring the delay time, the video data or the audio data can be used. Further, the delay time can be measured using an encoding-termination time and a decoding termination (or start) time so that the delay time in a network can be accurately measured. Also, the delay time can be measured using an encoding start time and a decoding start (or termination) time.

The data transmitted from the terminal at the transmission side to the monitoring device is whether a frame has been lost due to an error, a frame lost in a network due by an error, a delay time of a relevant frame. Since the data is transmitted to the monitoring device in real time, a user can check whether a relevant frame has been lost, the number of frames lost in a network, delay time information of a frame using the monitoring device.

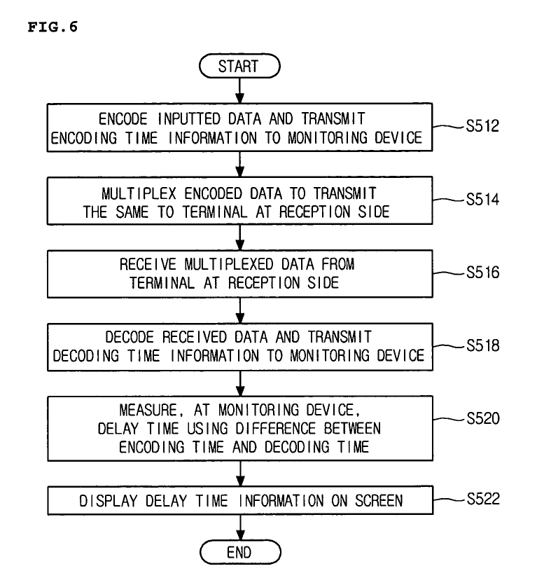

FIG. 6 is a flowchart of a method for verifying a delay time between mobile image terminals according to another embodiment of the present invention.

Referring to FIG. 6, the terminal at the transmission side encodes inputted video data and transmits an encoding-termination time information to the monitoring device (S512). Further, the terminal at the transmission side multiplexes the encoded data with other data (audio data, control data) and transmits the multiplexed data to the terminal at the reception side (S514).

After that, if the multiplexed data is looped back from the terminal at the reception side, the terminal at the transmission side receives the data (S516). The terminal at the transmission side demultiplexes the received multiplexed data and decodes video data among the demultiplexed data. At this point, the terminal at the transmission side transmits a decoding-termination time information to the monitoring device (S518).

The monitoring device measures delay time information using a difference between the encoding time and the decoding time (S520) and displays the measured delay time information on a screen (S522).

As described above, the monitoring device can detect a delay time of a relevant frame by receiving in real-time the encoding-termination time information and the decoding-termination time information from the terminal at the transmission side. At this point, the delay time information can be outputted by a frame unit or a time unit. Further, an average delay time, a maximum delay time, a minimum delay time can be quantitatively measured.

The terminal at the transmission side transmits a temporal reference (TR) value of a video frame to the monitoring device, so that the monitoring device can check the number of the frames being lost. That is, since the TR value has a sequential value between 0 and 127, the TR value is not sequential and lost in the middle if a frame is lost. Through the characteristic of the TR value, the lost frame can be checked.

As described above, the present invention can perform comparison/analysis of use environments, video data amounts, data change amounts between the terminals by measuring, analyzing, and verifying a real-time delay time of the image call under a mobile communication environment. A service provider can provide better image telecommunication service to a general public.

It will be apparent to those skilled in the art that various modifications and variations can be made in the present invention. Thus, it is intended that the present invention covers the modifications and variations of this invention provided they come within the scope of the appended claims and their equivalents.

1. A system for verifying a delay time using mobile image terminals, comprising:
a terminal at a reception side for looping back received data;
a terminal at a transmission side for transmitting data to the terminal at the reception side, and receiving the same data as the transmitted data through a loop-back from the terminal at the reception side to measure a delay time of the data; and
a monitoring device for monitoring delay time information of the data measured by the terminal at the transmission side to output the delay time information of the data.

2. The system according to claim 1, wherein the terminal at the transmission side measures the delay time of the data using an encoding time of the data and a decoding time of the looped-back data.

3. The system according to claim 2, wherein the delay time is a time obtained by subtracting an encoding-termination time of the data looped back to the terminal at the transmission side from a decoding-termination time of the data.

4. The system according to claim 2, wherein the delay time is a time obtained by subtracting an encoding-start time of the data looped back to the terminal at the transmission side from a decoding-start time of the data.

5. The system according to claim 1, wherein the terminal at the transmission side stores an encoding time of the transmitted data and a decoding time of the looped-back data, respectively.

6. The system according to claim 5, wherein the terminal at the transmission side provides in real time encoding time information and decoding time information of the data to the monitoring device.

7. The system according to claim 1, wherein the data used in measuring the delay time is video data.

8. The system according to claim 1, wherein the terminals at the transmission side and the reception side use H.324 protocol.

9. The system according to claim 1, wherein the monitoring device monitors in real-time information transmitted from the terminal at the transmission side to analyze and verify whether a frame has been lost, the number of lost frames by a network error, and frame delay time information.

10. The system according to claim 9, wherein the monitoring device analyzes/verifies in real-time the delay time by a frame unit and/or a time unit.

11. The system according to claim 1, wherein the monitoring device compares/analyzes the delay time due to an environment and video data change amount between the terminals at the transmission side and the reception side.

12. A method for verifying a delay time using mobile image terminals, comprising:
transmitting, at a terminal at a transmission side, data for an image communication;
receiving again the same data as the transmitted data through a loop-back by a terminal at a reception side; and
monitoring in real-time, at a monitoring device, time information generated by the transmitted data and the loop-back data to output delay time information of the data.

13. The method according to claim 12, wherein the time information monitored by the monitoring device is encoding time information of the transmitted data and decoding time information of the looped-back data.

14. The method according to claim 13, wherein the delay time information of the data measured by the monitoring device is measured from a difference between the encoding time of the transmitted data and the decoding time of the looped-back data.

15. The method according to claim 14, wherein the delay time of the data is a difference between a decoding-termination time of the looped-back data and an encoding-termination time of the transmitted data.

16. The method according to claim 14, wherein the delay time of the data is a difference between a decoding-start time of the looped-back data and an encoding-start time of the transmitted data.

17. The method according to claim 12, wherein the terminal at the transmission side measures the delay time information of the data using time information generated from the data and transmits the delay time information to the monitoring device.

18. The method according to claim 12, wherein the data used in measuring the delay time information is video data.

19. The method according to claim 12, wherein the data used in measuring the delay time information is audio data.

20. The method according to claim 12, wherein the monitoring device quantitatively displays a delay time average, a maximum delay time, and a minimum delay time using the delay time information of the data.
